(19) United States
(12) Patent Application Publication
(10) Pub. No.: US 2010/0031923 A1
(43) Pub. Date: Feb. 11, 2010

(54) Method and Apparatus for Detecting Engine Knock

(76) Inventor: Larry Lin Feng Weng, Sunnybank Hills (AT)

Correspondence Address: LUMEN PATENT FIRM, 350 Cambridge Avenue, Suite 100, PALO ALTO, CA, 94306, US

(21) Appl. No.: 12/085,871

(22) PCT Filed: Nov. 30, 2006
(86) PCT No.: PCT/AU2006/001814

§ 371 Date: Sep. 21, 2009

(30) Foreign Application Priority Data
Nov. 30, 2005 (AU) 2005906690

(51) Int. Cl. F02P 5/00; G06F 19/00

(52) U.S. Cl. 123/406.24; 701/111

(57) ABSTRACT

A an engine management system includes a processor (8) in communication with a memory (10) that contains a program memory (28) containing instructions for the processor to implement a knock detection method. The knock detection method involves firstly sampling a torque sensor (4) that is responsive to an engine crankshaft (5). The torque sensor is sampled a number of times during a combustion stroke of one or more of cylinders (18a, . . . 18d) of the engine (16). The sampled sensor values are processed to calculate a rate of change of the torque signal and knocking is deemed to be indicated in the event of the rate of change exceeding a predetermined value. In a preferred embodiment the processor (8) is further programmed to reduce knocking once it has been detected by adjusting one or more of a number of controllers including a fuel injection controller (34), an ignition controller (12), a throttle controller (13) and an exhaust gas recirculation controller (39).

### TECHNICAL FIELD

The present invention relates to engine management systems. Particular embodiments of the invention relate to a method and apparatus for detecting engine knocking or “pinging” as it is sometimes called.

### BACKGROUND

The reference to any prior art in this specification is not, and should not be taken as an acknowledgement or any form of suggestion that the prior art forms part of the common general knowledge.

The present invention is applicable to spark-ignition internal combustion engines in general, including four stroke and two stroke engines, reciprocating piston engines and rotary engines. For the purposes of explanation reference will made primarily to spark-ignition four stroke reciprocating piston engines.

The fundamental operational principles of four stroke internal combustion engines are well known. Basically, the spark-ignition cycle for a single system consists of four strokes. In the first, intake stroke, a fuel and air mixture is drawn into the combustion chamber through the intake valve as the piston is moving down to increase the volume of the chamber. During the intake stroke the pressure and temperature in the cylinder remain near outside conditions.

The second stroke is the compression stroke during which the fuel and air mixture is compressed as the piston moves up to reduce the volume of the chamber. The temperature in the chamber increases with the increasing pressure inside the chamber. At the end of the compression stroke, at which point the piston has risen to approximately top-dead-centre (TDC) a spark is introduced into the chamber which ignites the fuel mixture and causes it to combust.

The third stroke of the engine is the power stroke during which energy of the fuel is released at a rapid rate resulting in hot combustion gasses which push the piston down in turn rotating the engine crankshaft and developing torque. It will be realized that engine torque is a parameter dependent on the rate of energy release within the engine's combustion chamber. Other similarly dependent parameters include, for example engine vibration and the driving force, i.e. acceleration, developed by a vehicle driven by the engine.

In the fourth and final exhaust stroke the chamber exhaust valve opens and the combusted gas mixture is pushed out, by the rising piston, into the exhaust manifold.

It is well known that the air-fuel mixture does not combust instantaneously upon sparking at TDC. Typically it may take around 0.5 ms, i.e. 7.5 degrees of crank angle at 2500 RPM) after sparking for combustion to spread from a small region around the spark plug tip to the rest of the air-fuel mixture. The combustion region typically completes around 30 to 50 degrees of crank angle after sparking.

It will be realized that if the fuel mixture is sparked exactly on TDC then the piston will have progressed down the chamber a substantial distance before the major part of the air-fuel mixture has combusted. The later-combusting portion of the air-fuel mixture is unable to push the piston down as much as the earlier combusting portions so that less of the combustion energy is applied to the piston. In short, the engine operates in a less than optimal mode because the transfer of combustion energy to the piston, and hence to the crankshaft, is poorly timed.

In order to increase the transfer of energy to the piston it is common practice to set the spark timing so that sparking occurs before piston TDC. Consequently by the time the piston has passed TDC and is entering the power stroke, a relatively greater proportion of the air-fuel mixture is under combustion.

It will be realized that if the spark timing is advanced too far, that is too much prior to TDC, then the first stages of combustion of the air-fuel mixture will push against the piston during the final stages of the compression stroke and the engine will lose power as a result.

The ideal spark timing is a trade-off between loss of power due to initial combustion in the compression stroke and loss of power due to late combustion in the power stroke.

During the compression stroke the air fuel mixture reaches a high pressure as TDC is approached. This pressurization, along with the heat of the engine, causes the mixture to become very hot. If the compression ratio of the engine is sufficiently high then portions of the air-fuel mixture may combust independently of the applied spark. This phenomenon of uncontrolled combustion occurring during the compression stroke is sometimes called “pre-ignition” or “dieseling” and is relatively unusual in modern engines. A common cause of pre-ignition combustion, in those relatively instances where it does occur, is due to carbon build up or other hot spots within the combustion chamber.

During the power stroke, subsequent to the ignition point, some pockets of fuel may ignite ahead of the main combustion front—generally due to heat and pressure build up from the main combustion process. This phenomenon is known as “knocking” or “pinging” and comprises the extremely rapid combustion of a substantial portion of the air-fuel mixture so that pressure in the cylinder rises suddenly and unevenly. As a result a pressure wave reverberates throughout the cylinder causing adverse effects to the combustion cycle, high stresses on the engine and the metallic sound of pinging. In the event of knocking occurring before the piston reaches TDC then a large and sudden combustive force will be brought down upon the rising piston during the end of the compression stroke thereby causing a sudden loss of power and stressing the piston crank.

A number of approaches have been taken to reducing the likelihood of engine knocking occurring. These include, reducing engine compression ratios, retarding the spark timing and designing the combustion chamber to reduce the likelihood of combustion occurring independent of sparking.

It is an object of the present invention to provide a method and apparatus for detecting engine knock. It would also be desirable if a method and apparatus for reducing or avoiding engine knock, once detected, was provided.

### SUMMARY OF THE INVENTION

According to one aspect of the present invention, there is provided a method for detecting knocking in an engine, the method including the steps of:
sampling a parameter dependent on rate of energy release within one or more combustion chambers of the engine;
calculating a rate of change of the parameter;
deeming knocking to be indicated in the event of the rate of change exceeding a predetermined value;
wherein the parameter is sampled a plurality of times during a combustion stroke of at least one combustion chamber of the engine.

Preferably the parameter will be the engine's torque T and the rate of change of the parameter will generally be a numerical approximation of dT/dθ such as (T₂−T₁)/(θ₂−θ₁), where T₁ is the torque sampled at a first crankshaft angle θ₁ and T₂ is the torque measured at a subsequent crankshaft angle θ₂.

Where noise on the torque signal is a significant issue the performance of the system is, in the preferred embodiment, improved by calculating (Σ_{j=0 to n} Tᵢ₋ⱼ−Σ_{j=1 to n+1} Tᵢ₋ⱼ)/(θᵢ−θᵢ₋₁), where j and i are integer counter variables.

The method preferably includes sampling the engine's torque with a magneto-restrictive torque sensor although other types of torque sensor might also be used.

The method will preferably include measuring the crankshaft angle with the same sensor that determines the engine's torque.

A further step may be incorporated of calculating a knock intensity value indicating the difference between peak torque and the torque at the point where the rate of change exceeded the predetermined value.

Preferably the knock intensity value will be the difference between the peak torque value during the knocking and the torque value at the onset of knocking.

The peak torque value may be determined by detecting a change in sign of dT/dθ.

The method will preferably include a step of comparing the knock intensity value to a predetermined knock intensity value in order to confirm knocking.

The method will generally include a step of identifying which combustion chamber of the engine is associated with the knocking.

Preferably the step of identifying the combustion chamber associated with the knocking will involve referring to a combustion chamber ignition sequence for the engine.

In a preferred embodiment the method will include a step of adjusting at least one engine parameter to avoid knocking.

The method may include determining which one or more of the following parameters to adjust based on prevalent engine operating conditions:
rate of fuel injection,
rate of exhaust gas recirculation,
ignition timing,
manifold pressure,
air fuel ratio.

The at least one parameter that is adjusted may comprise ignition timing and/or manifold pressure. For example, manifold pressure may be adjusted by varying the operation of the engine's throttle.

The method may include retarding ignition timing by an amount dependent on the knocking intensity. Alternatively ignition timing may be retarded by a fixed amount independent of knocking intensity.

The method may include adjusting ignition timing and/or fuel injection parameters in response to onset of knocking caused by a change in fuel.

According to a further aspect of the present invention there is provided an engine management system including:
a processor in communication with an engine sensor input and an ignition control output; and
a memory accessible to the processor and containing instructions to implement a method as described above.

Preferably the engine sensor input comprises a torque sensor input and in the preferred embodiment the engine management system includes a torque sensor coupled to said input.

The engine management system may further include a number of controllers responsive to the processor to modify the operation of the engine.

The controllers will typically include one or more of: an ignition controller, a fuel injection controller and an exhaust gas re-circulation controller.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a four cylinder engine and transmission fitted with an apparatus according to a preferred embodiment of the present invention.

FIG. 2 is a torque to angular position graph of the engine of FIG. 1 showing signs of knocking in one cylinder.

FIG. 3 is a torque trace for a knock event in a single cylinder in a noise free environment showing the torque trace (referenced to the left vertical axis) and the absolute value of the first differential of the torque trace (referenced to the right vertical axis).

FIG. 4 is a torque trace, similar to that of FIG. 3, with the addition of random noise added into the torque signal.

FIG. 5 is a flowchart of a method according to a preferred embodiment of the present invention implemented by the apparatus of FIG. 1.

### DETAILED DESCRIPTION OF PREFERRED EMBODIMENTS

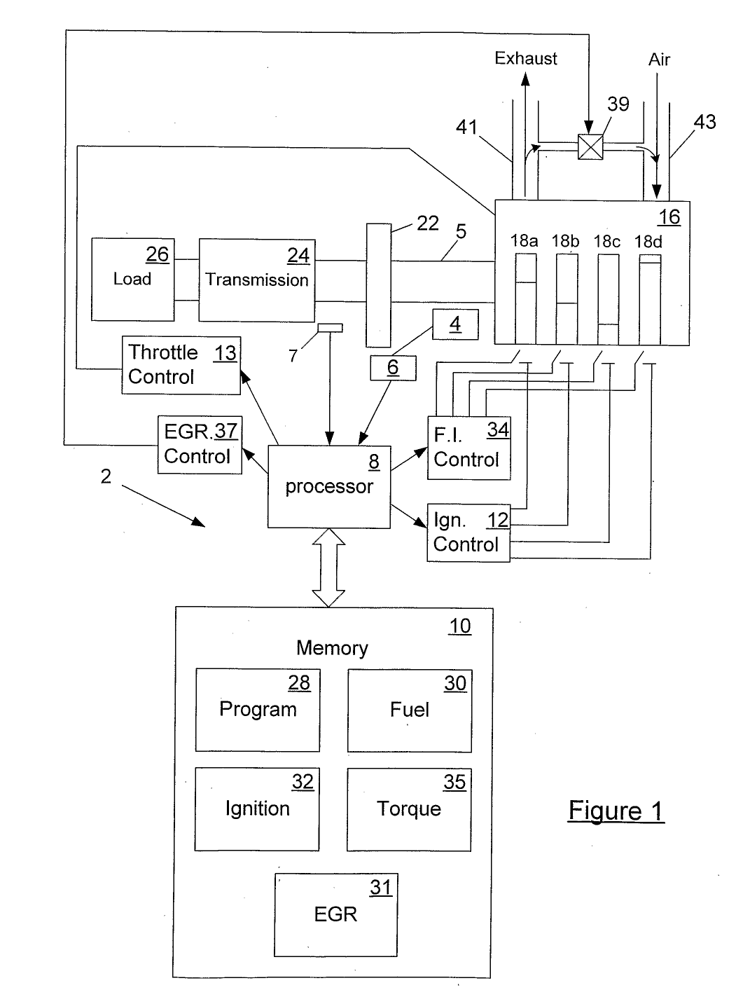

FIG. 1 is a block diagram of an engine and transmission system fitted with an engine management system 2 according to an embodiment of the present invention. Engine 16 includes four combustion chambers in the form of cylinders 18a, . . . , 18d which drive pistons coupled to a crankshaft 5 upon which a flywheel 22 is mounted. Crankshaft 5 is in turn coupled to a load 26, for example a vehicle's wheels, by a transmission 24.

The engine management system 2 includes a torque sensor 4 which is preferably a magneto-restrictive torque sensor as manufactured by NCTEngineering GmbH of Erlenhof-Park Inselkammerstr. 10 82008 Unterhaching, Germany. The sensor is arranged to sense engine torque from crankshaft 5 and is capable of sample rates of up to 29 kHz. Accordingly, the torque sensor allows torque values, which are in turn dependent on the rate of energy release within the engine's combustion chambers, to be sampled many times during a combustion stroke.

The output from torque sensor 4 passes to a signal conditioning module 6 which includes standard low pass filtering and analog-to-digital signal conversion circuits to provide a suitable digital signal for input to microprocessor 8.

Microprocessor 8 is able to determine the angle of the crankshaft 5 by means of a shaft angle sensor 7. Shaft sensing arrangements of this type are known in the prior art. Alternatively, certain types of torque sensor provided by NCTEngineering are able to provide absolute shaft angle data in which case a separate shaft angle sensor is not required. If a separate shaft angle sensor is used then it should have a resolution that is the same or higher than that of the torque sensor.

The microprocessor accesses a memory 10 which includes portions dedicated to program instruction memory 28 and ignition timing map memory 32. Preferably the program memory 28 includes instructions for processor 8 to perform a dynamic tuning method as explained in granted Australian patent No. 2004201718 by the present inventor. That method involves looking up, and updating various engine management parameters stored in maps, ie. portions of memory 10. In FIG. 1 the engine management parameters include fuel injection, ignition and exhaust gas re-circulation maps 30, 32 and 31 corresponding to torque values stored in torque map 35, which is also dynamically updated, on the basis of readings from torque sensor 4.

The ignition timing map 32 contains advancement and retardation values for advancing and retarding the spark timing for each of the four combustion chambers 18a, . . . , 18d of the engine. Similarly, the fuel injection map 30 contains fuel injection parameters in respect of each of the four cylinders and the EGR map 31 contains parameters for operation of EGR valve 39 at particular torque values.

The program memory 28 includes instructions to implement a method according to a preferred embodiment of the invention that will be described shortly.

An ignition controller module 12 operates in response to signals from the microprocessor to apply voltages to each of the four spark plugs for combustion chambers 18a, . . . , 18d respectively. Consequently, microprocessor 8 is able to independently spark each of the spark plugs in accordance with the values in ignition timing map 32.

Further output from microprocessor 8 controls fuel injection controller 34. In response to command signals from microprocessor 8 the fuel injection controller varies the volume and timing of fuel injected into each of combustion chambers 18a, . . . , 18d. Consequently, microprocessor 8 is able to independently vary the volume and timing of fuel introduced into each of combustion chambers 18a, . . . , 18d.

The engine depicted in FIG. 1 includes an exhaust gas re-circulation system by which an EGR valve 39 is located between exhaust pipe 41 and intake pipe 43. The EGR system facilitates the re-circulation of exhaust gases back into the engine to reduce the combustion temperature and emission which in turn may reduce the occurrence of knocking in some circumstances. EGR valve 39 is operated by an EGR controller 37 which is in turn responsive to signals from processor 8. Consequently processor 8 is able to control the volume of gas re-circulated from exhaust 41 to engine air inlet 43.

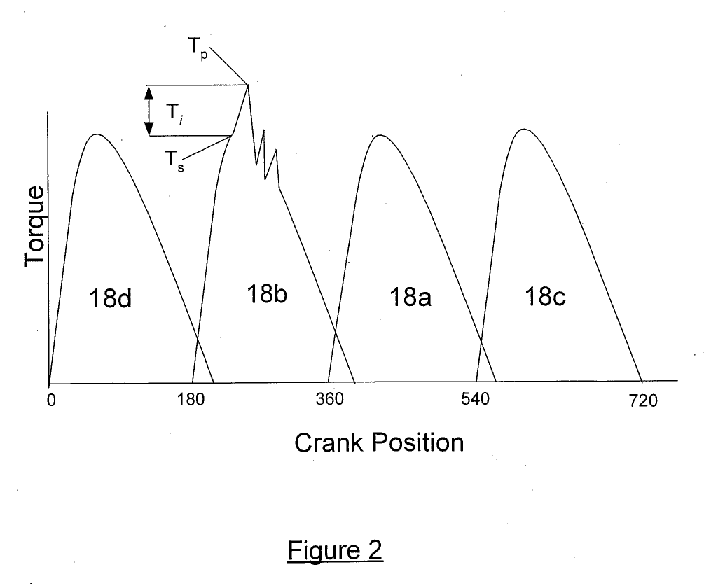

FIG. 2 is a graph showing a torque to crank position waveform for each of the four cylinders of engine 16 wherein a knocking event has occurred in cylinder 18b as indicated by the sharp peak on the waveform associated with that cylinder. It will be noted that the firing sequence of the chambers is 18d, 18b, 18a, 18c. The firing sequence for the particular engine 16 is stored in memory 10.

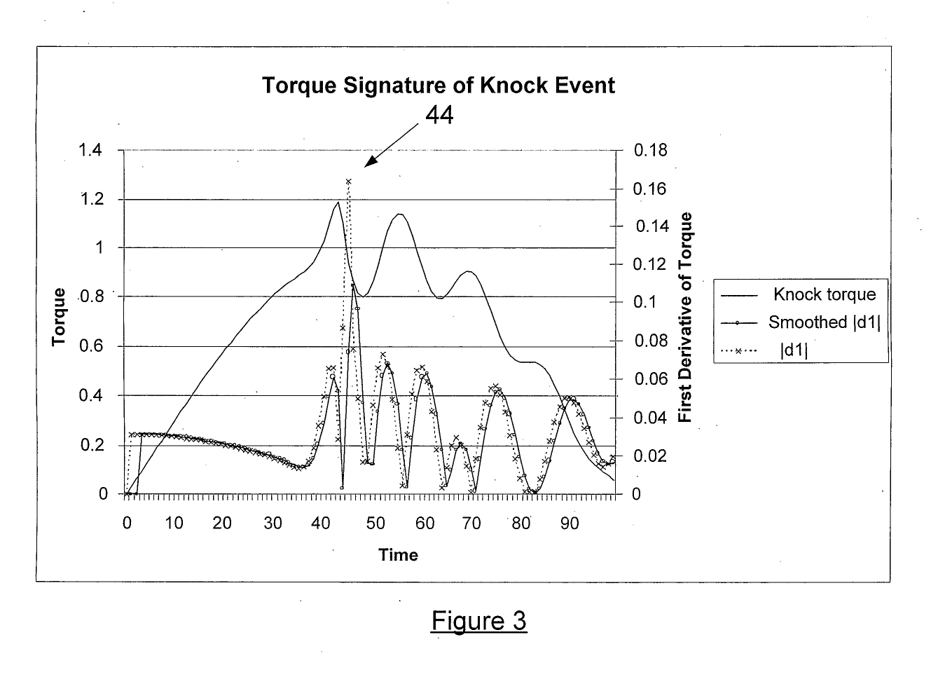

FIG. 3 shows the torque signal for a knock event along with the absolute value of the first derivative of that signal. A spike 44 in the first differential of the torque signal, which is indicative of knocking, can be easily seen.

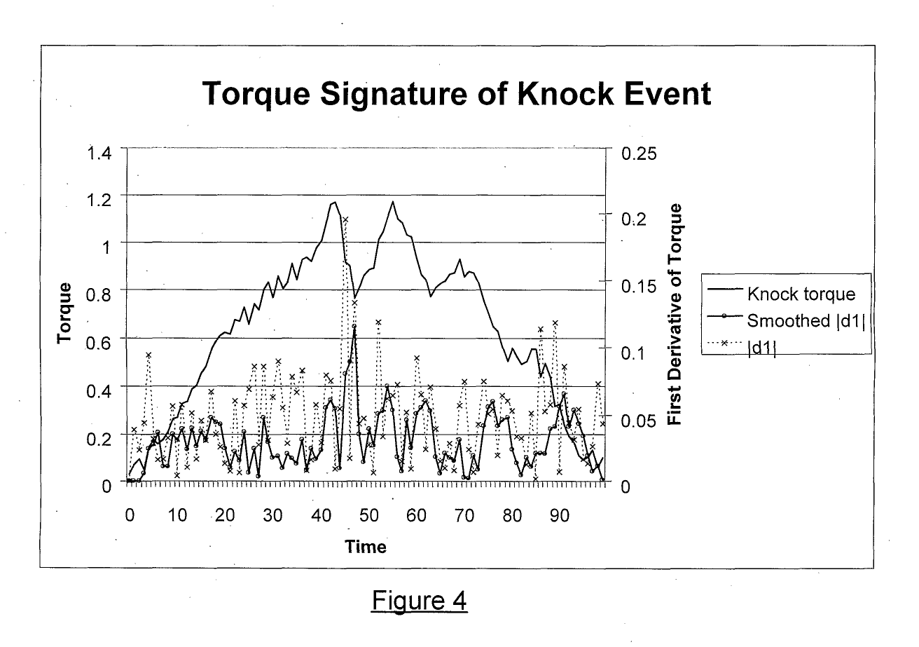

FIG. 4 is a torque trace of a knock event similar to that of FIG. 3 though with the addition of random noise to the torque signal. The resulting torque trace is referenced to the left vertical axis. Both the absolute value of the first differential of the torque trace and the absolute value of a smoothed version of the first differential of the torque trace are also shown (both referenced to the right vertical axis). It may be observed that the presence of high frequency noise adds many more “spikes” to the first differential of the torque signal. By smoothing this signal as will be described, to obtain the smoothed trace shown in FIG. 3, the amplitude of the noise induced “spikes” are substantially reduced so that a spike truly indicative of knocking may be more clearly detected.

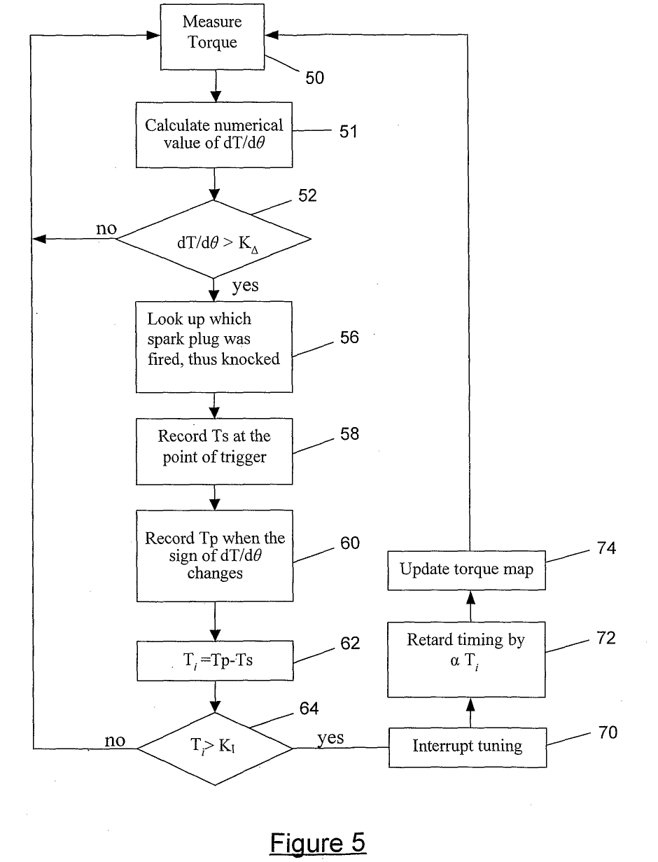

Referring now to FIG. 5, there is depicted a flowchart of a method according to a preferred embodiment of the present invention which engine management system 2 implements. The method is coded as instructions in a program stored in memory 28 for execution by processor 8.

At box 50 processor 8 measures a fresh torque value from sensor 4. Since the torque sensor samples at up to 29 kHz, and since spark ignition engines rarely operate at above 10,000 r.p.m the processor has access to at least 175 torque samples per revolution.

At box 51 the rate of change of the torque as a function of angle, dT/dθ, is calculated. At a minimum only two sequential values of each torque and crank angle are required. For example, a first torque value is taken at θ1 and then a second torque value is taken at θ2. The rate of change of the torque is then set to be simply the difference of the two torque values over the difference between the two sampling times.

At box 52 the rate of change dT/dθ is compared to predetermined rate of change threshold value K_{Δ}. If dT/dθ is greater than K_{Δ} then knocking may be occurring in one of the cylinders and control passes to box 56. Alternatively, if dT/dθ is less than the predetermined value of K_{Δ} then no knocking is detected and control loops back to box 50 to take the next torque measurement.

It should be noted, however, that if the torque signal is noisy, as shown in FIG. 4, then the calculation of the rate of change of the torque signal may require the torque signal to be smoothed and dT to be determined as the change in two successive smoothed values. In the preferred embodiment, this smoothing is achieved by calculating (Σ_{j=0 to n} Tᵢ₋ⱼ−Σ_{j=1 to n+1} Tᵢ₋ⱼ)/(θᵢ−θᵢ₋₁), where Tᵢ is a sampled value of the torque taken at θᵢ. Such smoothing must, however, be of sufficiently short time constant to avoid masking the dT associated with the knock event.

Given that knocking may be occurring then, at box 56, the particular cylinder that is affected is determined by reference to the engine's cylinder firing sequence. In a four cylinder engine, the crank duration between one power stroke and the next one is approximately 180° out of phase. If knock is going to occur then it may be expected within 90° crank degrees after the ignition. However, in a multi-cylinder engine such as a V6, V8 or more cylinder engine, the power stroke can be out of phase in a range of 60°-90°. Consequently, in some minor number of cases the knock of one particular cylinder might occur after the next firing cylinder. However, in the majority of cases the inventor believes that a knock can be expected to occur within 90° from the time of ignition.

At box 58 the torque reading Ts at the point that the rate of change of the torque signal, dT/dθ, equaled K_{Δ} is recorded. At box 60 the peak torque value Tp is stored. At box 62 the difference between the peak torque value Tp and the torque value Ts at which knocking was deemed to have commenced is calculated as Tᵢ.

At box 64 the torque intensity value Tᵢ is compared to a predetermined knock intensity threshold Kᵢ. If Tᵢ exceeds Kᵢ then knocking is deemed to have occurred and control passes to box 70. In the alternative, where no knocking is detected, control loops back to box 50 where the next torque measurement is made.

At box 70 the underlying dynamic engine tuning process is interrupted and at box 72 an engine parameter is adjusted to avoid subsequent knocking. In the preferred embodiment the engine parameter that is adjusted is the spark timing. The spark timing value in ignition map 32 for the current combustion chamber is retarded by an amount αTᵢ where α is a predetermined constant.

Consequently, in this embodiment the degree of retardation of the timing is proportional to the knock intensity Tᵢ. Other approaches are also possible however, for example, the timing might be retarded by a small constant amount independent of the value of the determined knock intensity. Apart from adjusting the spark timing to avoid knocking another parameter that might be adjusted is the degree of re-circulation of exhaust gases back into the engine. To accomplish this processor 8 sends signals to EGR controller 37 which in turn operates EGR valve 39 in order to vary the re-circulation of exhaust gases from exhaust outlet 41 to air inlet 43.

Engine knocking may also be prevented by reducing engine manifold pressure. This can be achieved, for example by processor 8 opening the engine's throttle by means of throttle controller 13 (FIG. 1).

A further way in which processor 8 may be able to reduce engine knocking is, where the engine is running on a lean fuel mixture, by reducing the air/fuel ratio by means of fuel injection controller 34 (FIG. 1).

The appropriate knock reduction strategy that is used may be based on the engine's operating conditions and coded as instructions in the program stored in memory 28.

At box 74 torque map 35 is updated in order that knocking be subsequently avoided.

The program in memory segment 28 may include instructions for the microprocessor 8 to compare the difference in torque generated when using different fuel initially at the same rate of fuel injection. The dynamic tuning algorithm then fine tunes the fuel injection to achieve maximum torque. The difference in torque value can then be used to determine an offset to be applied to the values in fuel map 30 in order to give a good initial point for controlling the fuel injector and ignition controller to optimize fuel efficiency for desired torque levels.

By using the torque sensor and the previously described method to detect knock it is possible to prevent the engine from operating in a region where knocking is likely to occur due to a change of fuel type and corresponding air/fuel ratio. Different fuel types have different chemical energies and hence require different air fuel ratios for their optimal combustion. By detecting knock and tuning for maximum torque it is possible to maximize the efficiency of the engine when using any particular fuel. A test tuning action can be used to safely tune for the current type of fuel being used. This is done by enriching the fuel mixture and measuring the change in torque with respect to the change in fuel quantity. Once the direction of change is determined, fuel quantity can be optimally tuned quickly.

For example, for a given for stroke engine, when changing from Octane 92 to Octane 98 petrol, the torque produced from the Octane 98 fuel will be 5 Nm higher than the torque produced using Octane 92 fuel with the same ignition setting. The difference recorded is used to calculate an offset value to apply to the values stored in fuel map 30.

A person skilled in the art will appreciate that embodiments and variations can be made without departing from the ambit of the present invention.

In compliance with the statute, the invention has been described in language more or less specific to structural or methodical features. It is to, be understood that the invention is not limited to specific features shown or described since the means herein described comprises preferred forms of putting the invention into effect.

1. A method for detecting knocking in an engine, the method including the steps of:
sampling the engine's torque T a plurality of times during a combustion stroke of at least one combustion chamber of the engine, the torque being dependent on rate of energy release within one or more combustion chambers of the engine;
calculating a rate of change of the torque;
deeming knocking to be indicated in the event of the rate of change exceeding a predetermined value;
calculating a knock intensity value, indicating the difference between peak torque and the torque at the point where the rate of change exceeded the predetermined value, as the difference between a peak torque value during the knocking and a torque value at the onset of knocking, the peak torque value determined by detecting a change in sign of the rate of change of the torque;
so that comparing the knock intensity value to a predetermined knock intensity value confirms the knocking.

2. A method according to claim 1, wherein the rate of change of the torque is a numerical approximation of the rate of change of the engine's torque.

3. A method according to claim 2, wherein the step of calculating includes determining a numerical approximation of the rate of change of the engine's torque as (T₂−T₁)/(θ₂−θ₁).

4. A method according to claim 2, wherein the step of calculating includes determining a numerical approximation of the rate of change of the engine's torque after taking a moving average of a series of torque values.

5. A method according to claim 4, wherein the step of calculating includes determining a numerical approximation of the rate of change of the engine's torque as (Σ_{j=0 to n} Tᵢ₋ⱼ−Σ_{j=1 to n+1} Tᵢ₋ⱼ)/(θᵢ−θᵢ₋₁).

6. A method according to claim 1, including sampling the engine's torque with a magneto-restrictive torque sensor.

7. A method according to claim 1, including measuring angular position of a crankshaft of the engine with a sensor that also produces a signal indicating the engine's torque.

8. A method according to claim 1, including a step of identifying which combustion chamber of the engine is associated with the knocking.

9. A method according to claim 8, wherein the step of identifying the combustion chamber associated with the knocking is performed with reference to a combustion chamber ignition sequence for the engine.

10. A method according to claim 1, including a step of adjusting at least one engine parameter to avoid knocking.

11. A method according to claim 10, wherein the at least one parameter that is adjusted comprises ignition timing.

12. A method according to claim 10, wherein the at least one parameter that is adjusted controls exhaust gas re-circulation in the engine.

13. A method according to claim 10, wherein the at least one parameter that is adjusted controls engine manifold pressure.

14. A method according to claim 11, including retarding ignition timing as a function of knocking intensity.

15. A method according to claim 10, including:
determining which one or more of the following parameters to adjust based on prevalent engine operating conditions:
rate of fuel injection,
rate of exhaust gas recirculation,
ignition timing,
manifold pressure,
air fuel ratio.

16. An engine management system including:
a processor in communication with an engine sensor input and an ignition control output; and
a memory accessible to the processor and containing instructions to implement a method according to claim 1.

17. An engine management system according to claim 16 including a torque sensor input.

18. An engine management system according to claim 16, wherein the engine management system includes a torque sensor coupled to said input.

19. An engine management system according to claim 18, including a number of controllers responsive to the processor to modify operation of the engine.

20. An engine management system according to claim 19, wherein the controllers include one or more of: an ignition controller, a fuel injection controller, an exhaust gas re-circulation controller, a throttle controller.

21-24. (canceled)
